(19) United States
(12) Patent Application Publication
(10) Pub. No.: US 2003/0169350 A1
(43) Pub. Date: Sep. 11, 2003

(54) Camera assisted method and apparatus for improving composition of photography

(76) Inventors: Avi Wiezel, Tempe, AZ (US); Gavril A. Margittai, West Vancouver (CA)

Correspondence Address: Avi Wiezel, 1620 E. Candlestick Dr., Tempe, AZ, 85283, US

(21) Appl. No.: 10/093,056

(22) Filed: Mar. 7, 2002

(51) Int. Cl. H04N 5/262

(52) U.S. Cl. 348/239

(57) ABSTRACT

A method and apparatus to position photographed subjects so that the finished product has consistent artistic quality composition is disclosed. Photo templates will be generated implementing proven expert artistic photographic composition methods. The digital camera operator may choose the appropriate template to be displayed on the camera's view window as a superimposed overlay atop the image seen through the view lens. The operator should adjust the subject to mimic the chosen template. In the main embodiment of the invention, said photo template may be stored electronically or directly overlaid on the camera's view window. The composition information available by choosing the photo template can indicate to the camera the region of interest for exposing and focusing, thus eliminating the guesswork of the camera's computer. The primary purpose of the invention is to help the unskilled photographer to take better snapshots. The invention can also be used as a teaching aid in photography classes.

### FEDERALLY SPONSORED RESEARCH

Not applicable

### SEQUENCE LISTING OF PROGRAM

Not applicable

### BACKGROUND

1. Field of Invention

The present invention relates generally to digital photography and in particular to improvement of composition quality when photographing people. This is achieved by using photographic templates.

2. Description of Prior Art

Photographers continually strive to visually stimulate audiences. There has been a tremendous technical progress in the field of photography. Couple of decades ago taking a simple snapshot was a relatively complicated task. It required the photographer to correctly estimate the amount of available light, to be able to accurately focus etc. All these problems have been solved by increasingly versatile cameras. Today even entry-level cameras are capable of calculating the required exposure and do automatic focusing. Why is it then that the average amateur snapshots are so dull and uninteresting? The answer is that taking a good picture, just like writing a good article or presentation, require more than a technically capable camera or word processor. They also require a good composition.

Modern word processing software and presentation builders (MS Word and PowerPoint) recognized this need and came up with several templates of presentations or letters to satisfy the most common situations. These templates help the novice author to create better structured and better composed work. The present invention is trying to apply this concept in the field of photography by offering ready-made photo templates for most common photographic situations.

Prior art has improved the aspects of exposure, magnification, and symmetry of photocomposition; yet, has not achieved a way to implement the artistic component. Artistic composition is achieved with experience. The present invention applies a method and apparatus to capture this experience to achieve consistent artistic composition.

Several attempts have been made to assist a photographer with the improvement of picture composition.

1. Okuzawa: Viewfinder for cameras U.S. Pat. No. 4,011,571.

Said patent is a mechanical system within the camera interconnecting the indication of the marks with the distance ring. This invention uses marks in the viewfinder sight field to properly center and adjust magnification of objects with respect to the camera lens system. The said system improves composition such that an image is centered and magnified to fill the composition area.

Artistic composition encompasses far more to visually stimulate viewers than centering and magnification. The proposed invention provides means of changing the overlay image according to the photographic situation and more importantly communicates proven arrangements and setups to the photographer. The electronic method proposed in the present invention is substantially superior to the mechanical one invented by Okuzawa because the photographer can pick and choose from a potentially large database according to his preference. The proposed invention is also capable of providing substantially more information to the photographer, as described subsequently.

A photo arrangement or photo template as described in the present invention is suggesting postures that visually express relationships between the photo subjects. A specific posture can communicate a strong visual message and photographers often arrange their subjects to express such messages. Okuzawa's invention does not address the posture of the subjects.

2. Ferrada Suarez: Picture composition guidance system U.S. Pat. No. 5,873,007.

Said patent deals with guiding composition related to landscapes where amateur photographers sometimes place the horizon line incorrectly and align the subjects in the center of the frame rather than at the strong points as recommended. Quoting from this patent: “What is needed is a user friendly guidance system that would aim the camera user in taking pictures with quality picture composition”. Said patent aims to achieve better compositions by displaying a series of straight guidance lines and strong points in the viewfinder. The present invention provides a more complete solution to the problem by suggesting proven compositions to appear sketched on the camera's screen and communicating to the camera the region of interest in the picture.

3. Suzuki: Camera capable of issuing composition information U.S. Pat. No. 5,831,670.

Said patent is a composition quality estimation circuit system that warns a photographer when composition is poor based on a degree of dispersion of view points not exceeding a specific allowable value. Based on general rules of composition the camera computer activates various indicators that recommend which way to change the camera position in order to correct said mistake. Said invention does not suggest any new composition.

4. Reynolds: Method of simulating personal individual art instruction U.S. Pat. No. 5,513,991

Said patent is providing a method for teaching art. The method utilizes a CD compact disc playable on a CD-I compact disc player hooked up to a TV set. Each compact disc showcases an instructor and background information. The instructor does the voice over, giving instructions at each step walking the student through all the stages of the painting. Then, a completed painting of said object appears, the completed painting having been executed by the instructor. The screens contain step-by-step images of different stages of completion. At each screen, the instructor talks about what he or she is doing and why. Said patent is using electronic means to teach traditional non-electronic graphic art. The student is creating his/her own piece using traditional tools of the trade, such as paint, paintbrushes, a canvas and an easel.

In the present invention, an electronic camera is used for capturing the image. Having the instructional information available inside the camera makes the system much more versatile. Although using the cues will teach the amateur photographer valuable lessons in composition, the purpose of using it is for instantly improving picture quality and is aimed at amateurs who are more interested in having good pictures than in improving their photographing skills.

### OBJECTS AND ADVANTAGES

Accordingly several objects and advantages over prior art are:

1. Availability of interchangeable photo templates (FIG. 1) to guide the amateur photographer in creating superior pictures

2. The amount of information provided by said photo template is much larger than possible using the prior art. Photo templates communicate postures and positions rather than simple framing guide

3. Expandable database of compositions not restricted by camera mechanical or circuit system.

4. Proactive said invention in lieu of a warning system.

5. Cue cards with lighting information and additional advice are made available to the photographer (FIG. 2).

6. Photo template information can be used by camera to more accurately expose and focus on the region of interest in the picture.

7. Zoom lens can be automatically set to appropriate value to match subject.

8. Photo template information can be used later on by photo editing software to produce a more accurate “Quick fix”.

9. No photographic experience needed for the utilization of the device.

10. Software program can be used to improve operator skill by comparing produced photograph to photo template and producing recommendations to more accurately imitate the photo template.

Further objects and advantages of said invention will become apparent from a consideration of the drawings and ensuing description.

### SUMMARY OF THE INVENTION

A method and apparatus to position photographed subjects so that the finished product has consistent artistic quality composition. Use digital camera display screen to provide photo templates as a superimposed overlay to the image seen through the camera lens.

By having photo templates readily available inside the camera for most common photographic situation, the job of composing and framing a picture becomes an easier task. Rather than reinvent each time a setup that will work, the photographer has the easier task of following the template. When trying to imitate well-proven setups the user picks up good photographing habits and knowledge.

Providing the camera with information about the subject through the chosen template helps said camera computer to pick the region of interest for exposure calculation and focusing.

### DRAWINGS

Drawing Figures

FIG. 1. Digital camera displaying the photo template as an overlay on camera's screen. When taking a picture, both through the lens image and the photo template are visible, for comparison.

FIG. 2. Sample Cue card with lighting information. Each photo template may have a cue card associated with it. Said cue card should be viewed on the camera's display screen before starting the photo session.

FIG. 3. Sample Cue card containing dos and don'ts. These advices should be consulted prior to arranging the subjects.

### REFERENCE NUMERALS IN DRAWINGS

| | | |
|---|---|---|
| 1 - overlay template | 2 - view window | 3 - digital camera |

### DETAILED DESCRIPTION

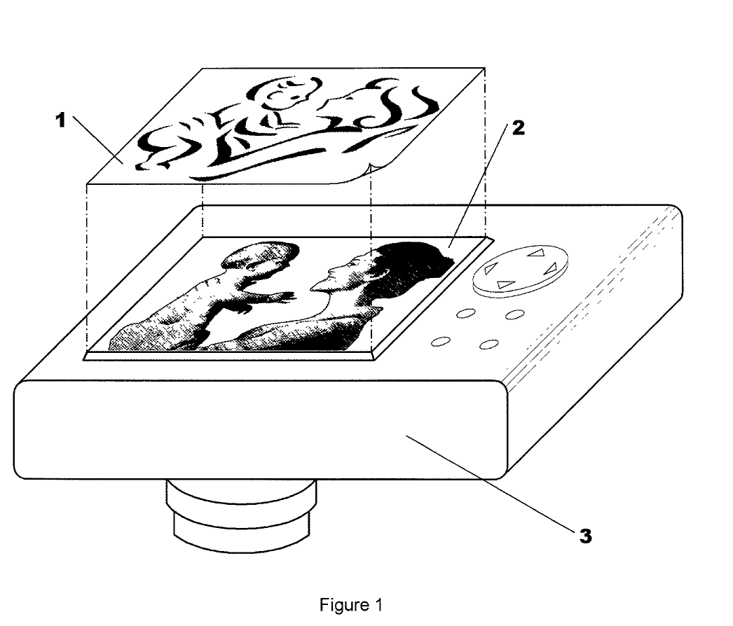

FIG. 1 shows a perspective view of a basic version of a photographic apparatus 3 equipped with software enabling the upload of photo templates 1 to be viewed atop image through the view window 2.

One source of said photo templates can be on, but not limited to, the CD supplied with the camera. When activating the camera software at the time it is connected to a PC the user would also be able to selectively upload templates of interest to the camera.

The camera software should be designed to have an additional mode, for example “Template View”. In this mode, templates can be examined on the camera's view window. Browsing the collection of templates can be done by viewing them one by one (single template playback) or as a “list of templates” (thumbnail display). A similar system is present in most digital cameras for examining captured photographs. After selecting the preferred template, the user pushes a button that advances to a new mode such as “Guided Photo”. In this mode, both the photo template and image seen through the view lens are displayed on the view window. The user may adjust the subjects, as do experienced professionals, until the photo image matches the photo template on the view window. At this point, artistic and technical adjustments are complete and the picture can be taken.

Photo Template

A photo template is a graphic representation of a composition involving people and objects. Template detail is kept to a minimum. In the preferred embodiment, said photo template is a monochrome image with no background. It is prepared by a graphic artist, or extracted by electronic means from existing pictures. The photo template is a sketch emphasizing only aspects related to composition. Minimizing detail allows said templates to be stored using a small amount of memory in an effort not to consume much of the camera's flash card capacity. Most of the template area being transparent should minimize interference with images seen through the view lens.

Template Classes

A template class is a directory of photo templates. It is similar in concept to a computer directory, which may contain several files and/or subdirectories. Said template class purpose is to reduce the task of navigating through the photo template collection. Templates should be grouped in classes according to subject matter. In the first embodiment, the user should be able to organize stored templates into appropriate classes according to preferences prior to uploading the templates to the camera.

Cue Cards or Screens

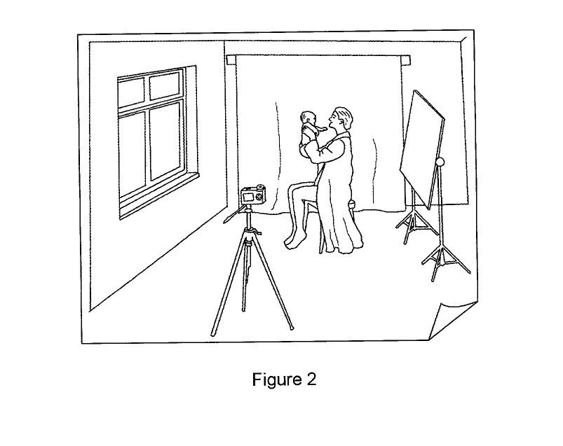

Cue cards (FIG. 2) can provide additional information regarding lighting scheme or other technical information deemed important by the expert preparing the photo templates. Said cards or screen are not compulsory, photo templates can be used without them. It is well known, by those skilled in the art of photography, that good composition alone does not necessarily lead to an artistically professional looking picture. Proper lighting of the subject plays an important role. To provide recommended lighting information, cue cards should be made available. Each photo template may have one or more linked cue screens. When a said photo template is chosen the appropriate cue screen(s) will also be selected. In this way, users can access said cue screens related to the chosen photo template without browsing. Consulting said cue screen(s) should ideally be done during the preparation stage and prior to subject positioning.

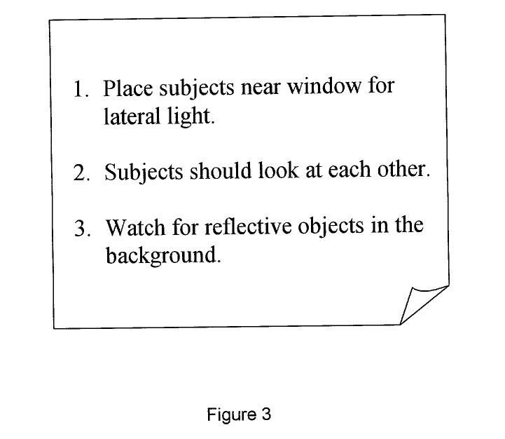

Besides lighting scheme, said cards might contain dos and don'ts similar to a Help menu (FIG. 3). They might be a text displayed on the camera's screen or audio information played through the camera's mini speaker.

Auto-Focus and Exposure Calculation

A method for more accurate auto-focus and exposure calculations based on availability of information from said photo template is proposed:

Camera computers experience difficulty when analyzing a picture to correctly determine the region of interest for auto focusing and exposure measurement. Said photo templates contain information regarding the main region of interest and communicate it to the camera's computer. This function will improve accuracy and superior picture quality.

Optimal Zoom Setting

A method for optimal zoom setting based on the availability of information from said photo template is proposed. For instance longer focal lengths are used for portraiture. In addition subject size, distance to subject, and existing light conditions play a role in determining the best focal length such that on camera flash can provide sufficient light. An adequate compromise can be made between the optimal focal length, aperture, existing light, and flash power.

Photo Template to Improve Quick Fix

Most picture editing computer programs have a command called Quick Fix or Auto Levels, that automatically adjust the picture color, contrast, and brightness to predetermined values. Even the most sophisticated programs cannot guess the intention of the photographer, the end result being a composite different from that envisioned. To alleviate this a photo template associated with a photo image indicating the main region of interest can improve the Quick Fix quality.

Photo Template Database

A large number of photo templates should be supplied with the CD enclosed with a new digital camera. The user should be able to upload them selectively to said camera. Novel and more specialized collections of templates should be downloadable from the Internet or other sources.

Second Embodiment of the Invention

There are a large number of digital cameras on the market. Although possible, it may be impractical to update their software to support photo templates. To enable usage of photo templates for said cameras a simpler solution is proposed. Create photo template transparencies having the size of the camera's display screen. Said transparencies should be organized in a booklet that would allow users to file in said template classes.

Before taking a picture, said photo template transparency needs to be affixed to the camera screen by some means. Usage of the template plate would be similar to one mentioned in the first embodiment.

The second embodiment does not provide photo template information to the camera regarding focusing, exposing, and zoom setting.

Typical Usage Flow:

When photographing people or group of people, the photographer decides to use photo templates appropriate for the occasion. Session preparation begins by uploading the preferred photo templates and organizing them into template class for navigation ease. Sources of photo templates can be the CD provided with the camera, the Internet, or templates created by the photographer from existing photos or graphic art. Next the camera is adjusted to “Template View” mode and the preferred photo template is chosen. The cue cards or screen may then be consulted to adjust lighting or this stage can be skipped. Camera is then adjusted to “Guide Photo” mode where both the photo template and subject seen through view lens are displayed on the view window. Using the provided information the user may adjust the subject to closely match the template. The composition can now be captured.

Photo Templates as a Teaching Aid

The photo template concept can be an effective tool for teaching photography. Multimedia method evolution is becoming increasingly ubiquitous to the point that one can imagine a whole photographic course delivered using photo templates. Providing feedback to students is simplified through the use of a computer by having a photo template and lighting scheme associated with the captured picture. Developing a software program to check contrast, accurate and appropriate lighting, magnification, composition, etc is realistically achievable.

Creating Photo Templates From Existing Photographs or Other Graphic Art

A software tool could be provided to create photo templates from existing graphic such that a user can create photo templates. Example:

If a photographer wants to recreate a modern digital photo version of Rembrandt's Anatomy lesson using his or her friends as cast; then, the picture can be scanned from an album or downloaded from the Internet and a photo template is generated.

### CONCLUSION, RAMIFICATIONS, AND SCOPE

The camera assisted method and apparatus for improving composition of photography helps inexperienced photographers in selecting photogenic arrangements and postures for the photographed subjects. It also conveys to the camera the intent of the photography, thus eliminating the guesswork of the camera's computer and improves both the artistic and the technical level of photographs.

Although the description above contains many specificities, these should not be construed as limiting the scope of the invention but as merely providing illustrations of some of the presently preferred embodiments of this invention.

Thus the scope of the invention should be determined by the appended claims and their legal equivalents, rather than by the examples given

What is claimed is:

1. An apparatus and photographic method comprising of a graphic representation of a photo arrangement called photo template displayed as a superimposed overlay on a camera viewing window whereby providing a multitude of photogenic composition setups to be used for arrangement of photographed subjects in a camera guided photography.

2. Cue cards associated with each said photo template as claimed in claim 1 to provide additional information regarding a specific arrangement of subjects whereby said cue cards can be displayed on camera's screen or played as a sound track on camera's speaker or provided as a separate booklet.

3. A method of accurate auto-focus and exposure calculation based on indication of region of interest by said photo template as claimed by claim 1, thereby eliminating the guess-work from said auto-focus and said exposure calculation algorithm.

4. A method for zoom setting appropriate for each particular subject as appearing on said photo template as claimed in claim 1.

5. A method for optimal flash setting based on the availability of information from said photo template as claimed in claim 1, providing an adequate compromise between the optimal focal length, aperture, ambient light, and flash power.
